(19) United States
(12) Patent Application Publication
(10) Pub. No.: US 2017/0198926 A1
(43) Pub. Date: Jul. 13, 2017

(54) HUMIDITY CONTROL APPARATUS

(71) Applicant: Mitsubishi Electric Corporation, Chiyoda-ku (JP)

(72) Inventors: Koji OTA, Chiyoda-ku (JP); Masahiro CHIKAISHI, Chiyoda-ku (JP); Yasutaka INANAGA, Chiyoda-ku (JP); Yasuhiro TANIMURA, Chiyoda-ku (JP)

(73) Assignee: Mitsubishi Electric Corporation, Chiyoda-ku (JP)

(21) Appl. No.: 15/325,976

(22) PCT Filed: Jun. 5, 2015
(86) PCT No.: PCT/JP2015/066374

§ 371 Date: Jan. 12, 2017

(30) Foreign Application Priority Data
Oct. 3, 2014 (JP) 2014-204386

(51) Int. Cl. F24F 3/14; F24F 11/00; B01D 53/32; F24F 3/147; B01D 53/26; B03C 3/08

(52) U.S. Cl. CPC F24F 3/1411; B01D 53/261; B03C 3/08; B01D 53/323; F24F 3/147; F24F 11/0008; F24F 2203/021

(57) ABSTRACT

A humidity control apparatus includes a housing having an air passage formed therein; a humidity control unit including a first conductive electrode provided in the air passage and having an adsorbent attached thereto, a second conductive electrode provided in the air passage and disposed along the first conductive electrode, and a third conductive electrode interposed between the first conductive electrode and the second conductive electrode and having a potential intermediate between potentials of the first conductive electrode and the second conductive electrode; a power supply unit configured to apply a voltage to the first conductive electrode and the second conductive electrode; and a fan configured to supply air to the air passage to cause the air to flow through the humidity control unit.

### TECHNICAL FIELD

The present invention relates to a humidity control apparatus that removes moisture in the air, or adds moisture to a room.

### BACKGROUND ART

Conventional humidity control apparatuses that have been proposed include one that includes a first heat exchanger and a second heat exchanger configured to alternately condense and evaporate refrigerant (see, e.g., Patent Literature 1). In the humidity control apparatus described in Patent Literature 1, an adsorbent that adsorbs moisture in the air is formed on the surface of the first heat exchanger.

### CITATION LIST

### Patent Literature

Patent Literature 1: Japanese Patent No. 3596549(see, e.g., lines 1 to 7 on page 1, FIGS. 1 and 2)

### SUMMARY OF INVENTION

### Technical Problem

In the humidity control apparatus described in Patent Literature 1, the adsorbent is formed on aluminum fins for heat exchange. There are some humidity control apparatuses in which a moisture adsorbing member containing moisture is disposed to be orthogonal to the direction of air flow. On the other hand, to prevent fins from blocking the air flow, heat exchangers are arranged such that the fins are, for example, parallel to the direction of air flow.

For example, in the case of fins whose surfaces are provided with an adsorbent, unlike in the case of the moisture adsorbing member that allows air to internally pass therethrough, it is difficult to improve the efficiency of moisture adsorption and desorption.

The present invention has been made to solve the problem described above. An object of the present invention is to provide a humidity control apparatus capable of adsorbing and desorbing moisture with high efficiency.

### Solution to Problem

A humidity control apparatus according to an embodiment of the present invention includes a housing having an air passage formed therein; a humidity control unit including a first conductive electrode provided in the air passage and having an adsorbent attached thereto, a second conductive electrode provided in the air passage and disposed along the first conductive electrode, and a third conductive electrode interposed between the first conductive electrode and the second conductive electrode and having a potential intermediate between potentials of the first conductive electrode and the second conductive electrode; a power supply unit configured to apply a voltage to the first conductive electrode and the second conductive electrode; and a fan configured to supply air to the air passage to cause the air to flow through the humidity control unit.

### Advantageous Effects of Invention

In the humidity control apparatus according to the embodiment of the present invention, ionic wind is generated by, an electric field generated between the first conductive electrode having the adsorbent attached thereto and the third conductive electrode paired with the first conductive electrode and an electric field generated between the third conductive electrode and the second conductive electrode paired therewith. The ionic wind generates an air current that carries moisture in the processed air toward the adsorbent, increases the probability of collision between the adsorbent and the moisture in the air, and improves the adsorption efficiency. Turbulence generated by the ionic wind facilitates movement of water molecules away from the adsorbent, and this improves the desorption efficiency.

### BRIEF DESCRIPTION OF DRAWINGS

FIG. 1 is a schematic diagram illustrating a general configuration of a humidity control apparatus 100 according to Embodiment 1 of; the present invention.

FIG. 2 is a control flowchart of the humidity control apparatus 100 according to Embodiment 1 of the present invention.

FIG. 3 shows a spectrum of ions generated by electrical breakdown between electrodes 21 and 22.

FIG. 4 illustrates an effect of the humidity control apparatus 100 according to Embodiment 1 of the present invention.

FIG. 5 is a schematic diagram illustrating a modification of a humidity control unit 2 (humidity control unit 20) of the humidity control apparatus 100 according to Embodiment 1 of the present invention.

FIG. 6A illustrates a first mode of the humidity control unit 2 of the humidity control apparatus 100 according to the modification.

FIG. 6B illustrates a second mode of the humidity control unit 2 of the humidity control apparatus 100 according to the modification.

FIG. 7A illustrates a humidity control apparatus 200 according to Embodiment 2 of the present invention in which a humidity control unit 2a performs an adsorption process and a humidity control unit 2b performs a desorption process.

FIG. 7B illustrates the humidity control apparatus 200 according to Embodiment 2 of the present invention in which the humidity control unit 2a performs a desorption process and the humidity control unit 2b performs an adsorption process.

FIG. 8 is a control flowchart of the humidity control apparatus 200 according to Embodiment 2 of the present invention.

FIG. 9A illustrates a configuration and a dehumidifying operation of a humidity control apparatus 300 according to Embodiment 3 of the present invention.

FIG. 9B illustrates a humidifying operation of the humidity control apparatus 300 according to Embodiment 3 of the present invention.

FIG. 10 is a control flowchart of the humidity control apparatus 300 according to Embodiment 3 of the present invention.

### DESCRIPTION OF EMBODIMENTS

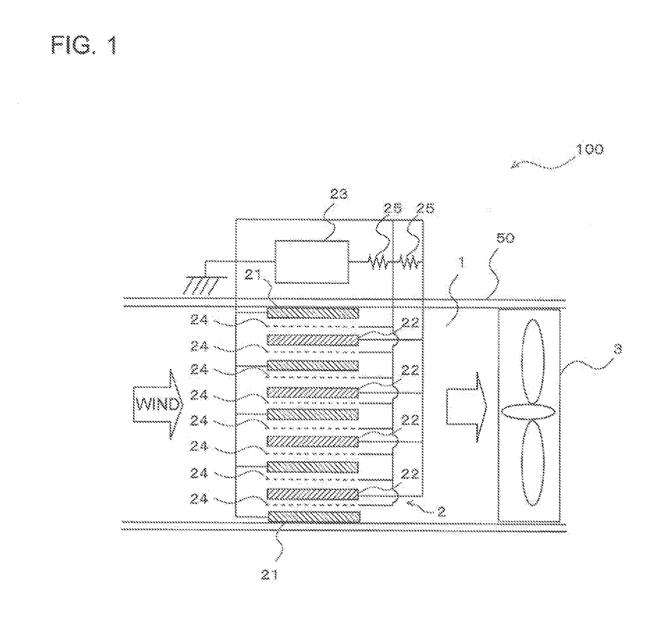

A humidity control apparatus 100, a humidity control apparatus 200, and a humidity control apparatus 300 according to Embodiments 1 to 3 of the present invention will now be described with reference to the drawings. In the following drawings including FIG. 1, components denoted by the same reference numerals are the same or equivalent components and are common throughout Embodiments 1 to 3.

### Embodiment 1

FIG. 1 is a schematic diagram illustrating a general configuration of the humidity control apparatus 100 according to Embodiment 1. The humidity control apparatus 100 includes a housing 50 having an air passage 1 formed therein. The humidity control apparatus 100 includes a humidity control unit 2 corresponding to the configuration of electrodes and other components. The humidity control unit 2 includes electrodes 21 provided in the air passage 1 and having an adsorbent attached thereto, electrodes 22 provided in the air passage 1 and disposed along the electrodes 21, and electrodes 24 each interposed between adjacent electrodes 21 and 22. Note that the electrodes 21 and 22 and the electrode 24 form a set of electrodes. The electrodes 21 and 22 and the electrodes 24 are arranged parallel to the direction of air flow to reduce an increase in pressure loss. At the same time, the electrodes 21 and 22 and the electrodes 24 are arranged such that the direction of an electric field formed by the electrodes 21 and 22 is orthogonal to the direction of wind flow. The electrodes 24 are each interposed between adjacent electrodes 21 and 22. That is, the electrodes 21 and 22 are arranged with predetermined spaces therebetween, and the electrodes 24 are each disposed in the corresponding space. For example, the electrodes 24 have a mesh-like shape. This means that air passing between the electrodes 21 and 22 can pass through the holes in the mesh-like electrodes 24. It is thus possible to reduce blockage of the flow of air between the electrodes 21 and 22. Note that the electrodes 21 correspond to a first conductive electrode, the electrodes 22 correspond to a second conductive electrode, and the electrodes 24 correspond to a third conductive electrode.

The humidity control apparatus 100 includes a power supply unit 23 configured to apply a voltage to the electrodes 21, electrodes 22, and electrodes 24, a fan 3 configured to supply air to the air passage 1 to cause the air to flow through the humidity control unit 2, and a controller 70 configured to control the power supply unit 23 and the fan 3. Since it is preferable that the electrodes 24 have a potential intermediate between those of the electrodes 21 and 22 and have an inter-electrode potential gradient, the voltage of the power supply unit 23 is lowered by resistors 25. The humidity control apparatus 100 is configured such that the fan 3 draws air into the air passage 1 and sends it to the humidity control unit 2,

The electrodes 21 are obtained by attaching an adsorbent to conductive electrodes. Examples of the adsorbent include silica gel, zeolite, lithium chloride, and polyacrylic acid polymer that can easily adsorb moisture. The electrodes having the adsorbent attached thereto are arranged at intervals of about 3 mm to 30 mm to be parallel with the flow of wind. The electrodes 22, which are flat plate-like conductive electrodes, are each inserted between adjacent flat plate-like electrodes 21 such that the distance between the electrodes 21 is halved. For example, the distance between adjacent electrodes 21 and 22 is about 1.5 mm to 15 mm. To keep the inter-electrode distance constant, insulating spacers are preferably provided between adjacent electrodes 21 and 22 to ensure equal intervals. The power supply unit 23 applies a voltage of 1000 V to 30000 V between the electrodes 21 and 22. The voltage is divided by the resistors 25, so that a voltage of 500 V to 15000 V is applied between the electrodes 21 and 24 and between the electrodes 22 and 24.

The voltage waveform used here may be, for example, a direct-current wave, an alternating-current wave, a rectangular wave, or a unipolar pulse wave, In the case of using a unipolar pulse wave, making the repetition frequency of pulses variable is desirable in that the level of power to be supplied can be changed in accordance with the frequency, and that an applied pulsed voltage causes an electric field between electrodes to appear and disappear. In the case of using a direct-current wave or unipolar wave, a voltage is applied to increase the potential of the electrodes 21.

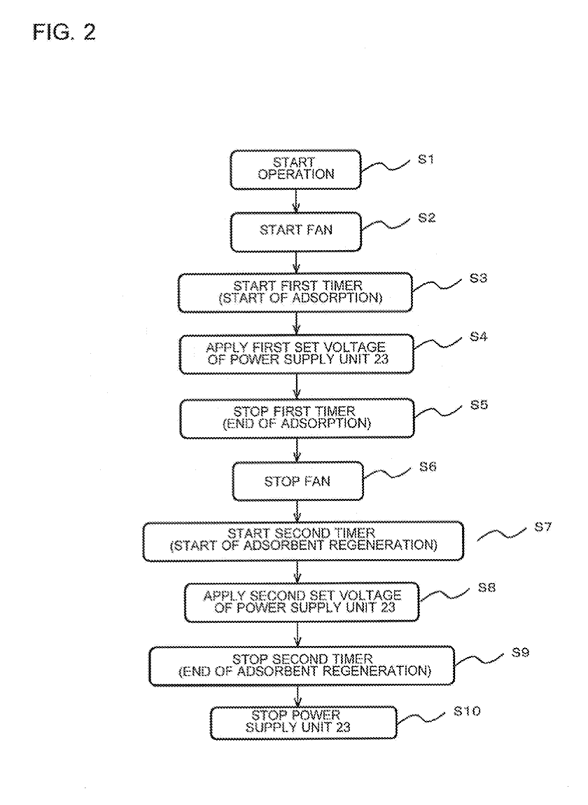

FIG. 2 is a control flowchart of the humidity control apparatus 100 according to Embodiment 1. The operation of the humidity control apparatus 100 will be described with reference to FIG. 2. In response to an instruction to start the operation (step S1), the fan 3 starts to rotate (step S2). The, controller 70 starts a first timer (step S3). Then, a high voltage set for adsorption is applied to start adsorption of water molecules in the air (step S4). If spark discharge starts, the adsorbent on the electrodes 21 is damaged. Therefore, an applied voltage V (V) is set to a value that satisfies the following equation (1) where d (mm) is a distance between the electrodes 21 and 22.

V≦10000d (1)

After operation for a predetermined period of time set on the first timer (step S5), the controller 70 stops the fan 3 to end the adsorption (step S6). Then, the controller 70 starts a second timer (step S7) and increases the power supplied by the power supply unit 23 (step S8). When the second timer ends (step S9), the controller 70 stops the power supply unit 23 (step S10). The operation is thus completed.

An electric field between the electrodes 21 and 22 is formed in the direction from the electrodes 21 toward the electrodes 22 because the electrodes 21 have a high potential. Since the potential of the electrodes 22 is low, electrons emitted from the electrodes 22 move toward the electrodes 21 along a line of electric force formed between the electrodes.

If electrical breakdown occurs between the electrodes 21 and 22, negative ions formed by ionization or electron attachment, such as oxygen ions, nitrogen oxide ions, or carbonate ions, move from the electrodes 22 toward the electrodes 21. These electrons and negative ions collide with neutral gas molecules to generate ionic wind.

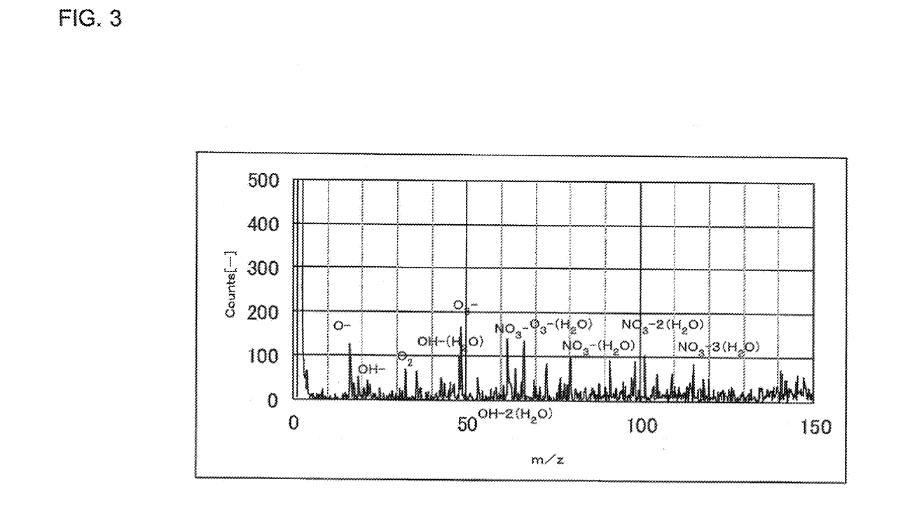

FIG. 3 shows a spectrum of ions generated by electrical breakdown between the electrodes 21 and 22. Ions generated by electrical breakdown will be described with reference to FIG. 3. FIG. 3 shows a measurement of negative ions generated by electrical breakdown, measured by an atmospheric pressure mass spectrometer. The horizontal axis represents the mass number, and the vertical axis represents the number of negative ions. The generated negative ions mainly include oxygen atomic ions, hydroxyl ions, ozone ions, nitrogen trioxide ions, and any of these ions to which clusters of water molecules are attached.

Moisture adsorption is promoted by the effect where ionic wind causes moisture in the air to collide with the electrodes 21 having the adsorbent attached thereto, and also by the effect where moisture in the air is attached as clusters to negative ions and collides with the adsorbent. On the other hand, desorption is promoted by heat energy generated by discharge between the electrodes 21 and 22.

In adsorption and desorption (regeneration), moisture adsorbed by the adsorbent reacts with electrons to turn into highly reactive oxygen atom radicals, hydroxyl radicals, oxygen ions, and ozone, which can decompose malodorous molecules adsorbed or removed simultaneously with water molecules.

The fan 3 is stopped for regeneration of the adsorbent as described above. However, if air generated in the regeneration is used for humidification, or if an exhaust line (not shown) is additionally provided in the air passage 1, the regeneration of the adsorbent may be performed by applying a high voltage during operation of die fan 3.

The fan 3 may be configured to switch between causing air to flow from left to right (forward direction) in the drawing and causing air to flow from right to left (inverse direction) in the drawing. In this case, for example, the housing 50 may be provided with one or more fans 3, which are controlled to cause air to flow in the forward direction during adsorption and to cause air to flow in the inverse direction during regeneration.

Although switching between adsorption and regeneration is made in accordance with the time set on the timer, a humidity sensor may be used for the switching. In this case, the value of the humidity sensor is set to a predetermined value, so that the switching is made when the predetermined value is reached. This can improve the accuracy of humidity control.

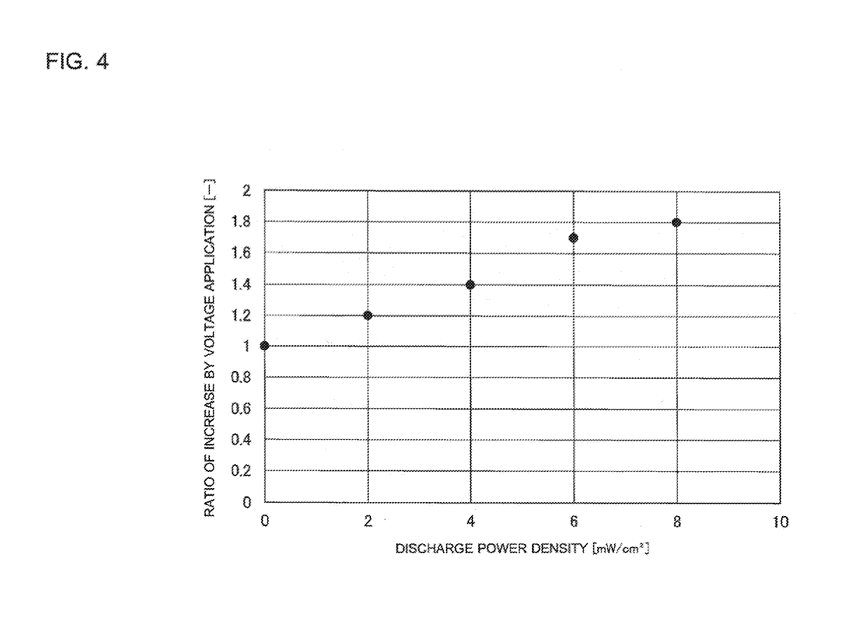

FIG. 4 illustrates an effect of the humidity control apparatus 100 according to Embodiment 1. An effect of adsorption and desorption achieved by discharge illustrated in FIG. 4. In FIG. 4, the horizontal axis represents a discharge area density (mW/cm²) obtained by dividing a discharge power, which is a product of a voltage applied during discharge and a discharge current, by an electrode area, whereas the vertical axis represents an adsorption or desorption performance ratio per unit time, with the amount of adsorption or desorption in the absence of discharge being taken as 1. As shown, the performance is improved by 20% at a supplied discharge power density of 2 mW/cm², improved by 40% at 4 mW/cm², and improved by 80% at 8 mW. This is probably because electrical breakdown of air between electrodes caused by an increase in discharge power density leads to an increased speed of ionic wind, and also because an increase in the number of generated negative ions leads to an increased weight of clustered water molecules.

The adsorbent attached to the electrodes 21 is a non-conductive material that does not conduct electric charge. Therefore, when ionized water vapor is adsorbed by the adsorbent, the amount of electric charge increases with time and the electrodes 21 become electrically charged. In the absence of the electrodes 24, an electric field generated by the electric charge on the adsorbent attached to the electrodes 21 cancels out the electric field generated between the electrodes 21 and 22. As a result, an electrostatic force decreases with time, and the amount of adsorbed moisture is reduced. However, with the electrodes 24, even when an electric charge accumulates on the adsorbent attached to the electrodes 21, the amount of water vapor that collides with the electrodes 21 is not reduced, because of the inertial force of electrostatic force generated by an electric field between the electrodes 22 and 24.

### [Modification]

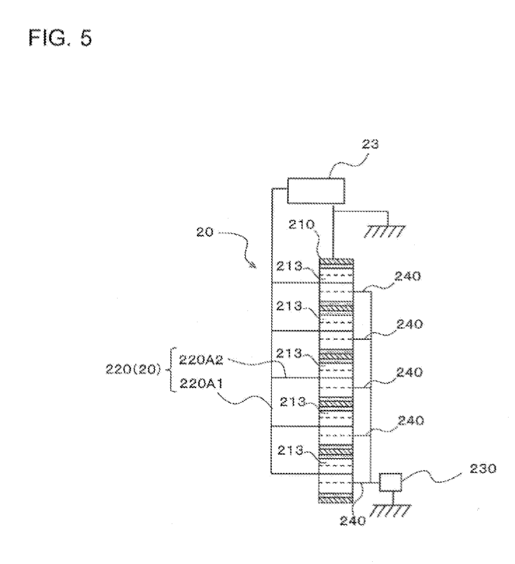

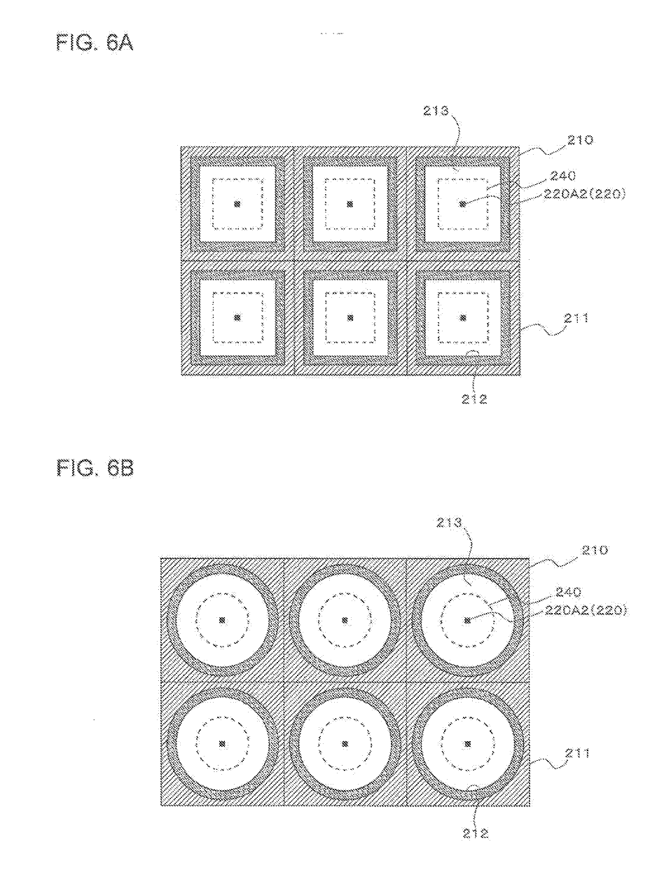

FIG. 5 is a schematic diagram illustrating a modification of the humidity control unit 2 (humidity control unit 20) of the humidity control apparatus 100 according to Embodiment 1. FIG. 6A illustrates a first mode of the humidity control unit 2 of the humidity control apparatus 100 according to the modification: FIG. 6B illustrates a second mode of the humidity control unit 2 of the humidity control apparatus 100 according to the modification.

In Embodiment 1, the electrodes 21 and 22 are arranged such that the direction of the electric field generated by the electrodes 21 and 22 is orthogonal to the direction of wind flow, but the configuration is not limited to this. As illustrated in FIG. 5 and FIGS. 6A and 6B, electrodes 210 and 220 and electrodes 240 are arranged such that the direction of the electric field generated by the electrodes 210 and 220 and electrodes 240 is along the direction of wind flow.

In the first mode of the humidity control unit 2 illustrated in FIG. 6A, holes (through holes 213) in areas where the electrodes 220 and 240 are arranged are rectangular in cross section. In the second mode of the humidity control unit 2 illustrated in FIG. 6B, holes (through holes 213) in areas where the electrodes 220 and 240 are arranged are circular in cross section. For the rest, the first mode of the humidity control unit 2 and the second mode of the humidity control unit 2 are the same in configuration.

The electrodes 210 are conductive porous members that allow passage of air therethrough. That is, the electrodes 210 are flat plate-like or rectangular parallelepiped members that are thick enough to have a plurality of through holes 213, and an adsorbent 212 is attached onto partition walls 211 that separate the through holes 213. The electrodes 240 are each interposed between the adsorbent 212 and the corresponding electrode 220A. With this configuration, the electrodes 210 increase the area where moisture is adsorbed. The electrodes 210 are arranged in the air passage 1 such that the forming direction (penetrating direction) of the through holes 213 are parallel to the direction of air flow. This reduces an increase in pressure loss.

The electrodes 220 have ladder-like base portions 220A1 and a plurality of needle-like protrusions 220A2 formed in the base portions 220A1. That is, to generate an electric field along the direction toward the partition walls 211, the electrodes 220 have the protrusions 220A2 protruding toward the electrodes 210. The protrusions of the electrodes 220 are preferably located at the respective centers of the through holes 213.

The electrodes 240 are each disposed to surround the corresponding protrusion 220A2. Also, the electrodes 240 are disposed to avoid contact with the protrusions 220A2 and the adsorbent 212. The electrodes 240 may be in the shape of a mesh made of a metal material. It is thus possible to reduce blockage of the flow of wind from the protrusions 220A2 toward the adsorbent 212. When the adsorbent 212 is a material that is easily electrically charged, the electrodes 240 are preferably disposed near the adsorbent 212.

In the present modification, the power supply unit 23 applies a voltage to the electrodes 210 and 220 such that the potential of the electrodes 210 is higher than that of the electrodes 220. A power supply unit 230 may apply a potential intermediate between those of the electrodes 210 and 220 to the electrodes 240. The power supply unit 230 preferably has a variable output voltage and increases the output in accordance with the amount of electric charge on the adsorbent 212.

When the electrodes 220 have the protrusions 220A2, a discharge start voltage is lower in the case of applying a high negative voltage. Accordingly, the power supply unit 23 may apply a voltage to the electrodes 210 and 220 such that the electrodes 21 have a zero potential connected to the earth and the electrodes 22 have a high negative voltage.

In electrodes 6B, the through holes 213 in the electrodes 210 are circular in shape and are arranged, with the protrusions 220A2 located at the respective centers of the through holes 213. It is thus possible to maintain equal distances between the protrusions 220A2 and the respective electrodes 240 and between adjacent electrodes 210, and to achieve a uniform electric field strength.

In the present modification, an electric field extending from the partition walls 211 of the electrodes 210 toward the electrodes 240 and an electric field extending from the electrodes 240 toward the tips of the protrusions 220A2 of the electrodes 220 are generated. Therefore, ionic wind is generated by the effect where electrons emitted from the tips of the protrusions 220A2 of the electrodes 210 move toward the partition walls 211 of the electrodes 210 having the adsorbent 212 attached thereto, and the effect where generated negative ions move toward the partition walls 211 having the adsorbent 212 attached thereto. The generated ionic wind increases the probability of contact between the adsorbent 212 attached to the partition walls 211 and water molecules in the air, and improves the efficiency of adsorption and desorption. Even when an ionized material is attached to the adsorbent 212 to electrically charge the adsorbent, the ionic wind from the electrodes 220 toward the electrodes 240 increases the probability of contact between the adsorbent 212 and water molecules in the air, and improves the efficiency of adsorption and desorption.

### (Effect of Humidity Control Apparatus 100 of Embodiment 1,)

In the humidity control apparatus 100 according to Embodiment 1, an electric field generated between the electrodes 21 having an adsorbent attached thereto and the electrodes 22 paired with the respective electrodes 21 can generate ionic wind, and this produces a first action by which an air current that carries moisture in the processed air toward the adsorbent is generated. By producing this first action, the humidity control apparatus 100 of Embodiment 1 increases the probability of collision between the adsorbent and moisture in the air, and improves the adsorption efficiency.

When water molecules eater vapor) are given an electric charge by attachment of electrons thereto, a second action that generates an electrostatic force is produced. This increases the probability of collision between the adsorbent and the water molecules, and improves the adsorption efficiency. There are other cases of improving the adsorption efficiency, than the case where the water molecules are given an electric charge. That is, when neutral molecules in the air are given an electric charge by attachment of electrons thereto, or when particles are ionized by cosmic rays, the molecules having an electric charge or the ionized particles are clustered together with moisture in the air, and the resulting clusters have an electric charge. The second action also occurs in the dusters, and this increases the probability of collision between the adsorbent and water molecules and improves adsorption efficiency.

The humidity control apparatus 100 according to Embodiment 1 can produce not only the first action, but also the second action described above. This further increases the probability of collision between the adsorbent and moisture in the air, and further improves adsorption efficiency.

In the humidity control apparatus 100 according to Embodiment 1 when moisture is desorbed from the adsorbent adsorbing the moisture, turbulence generated by ionic wind facilitates movement of moisture away from the adsorbent, and this improves the desorption efficiency. That is, in the humidity control apparatus 100 according to Embodiment 1, heat generated by discharge activates the transfer of molecules, and improves desorption efficiency.

### Embodiment 2

Since the humidity control apparatus 100 includes only one humidity control unit 2 in Embodiment 1, the dehumidifying process is not performed during regeneration of the adsorbent. In Embodiment 2, there are provided a plurality of humidity control units (a humidity control unit 2a and a humidity control unit 2b) and at least one of them performs an adsorption process and at least one of them performs an adsorbent regenerating process, so that air can be processed continuously.

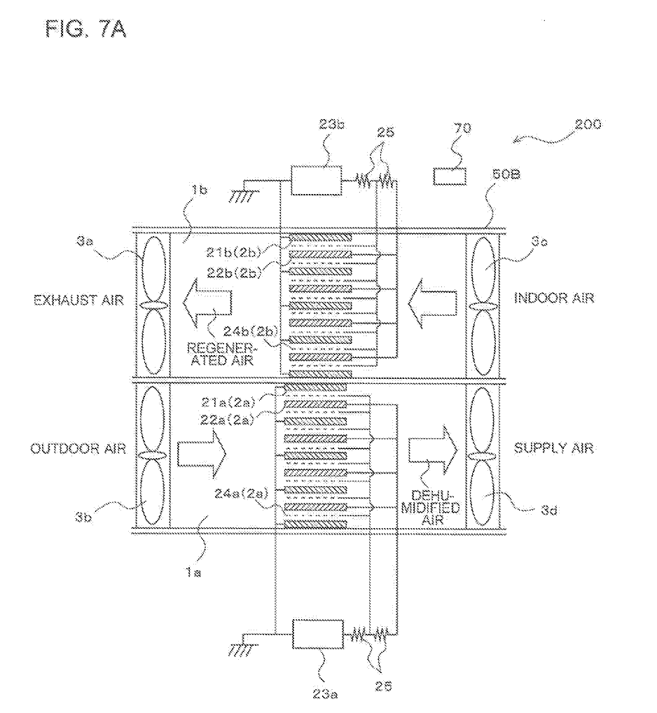

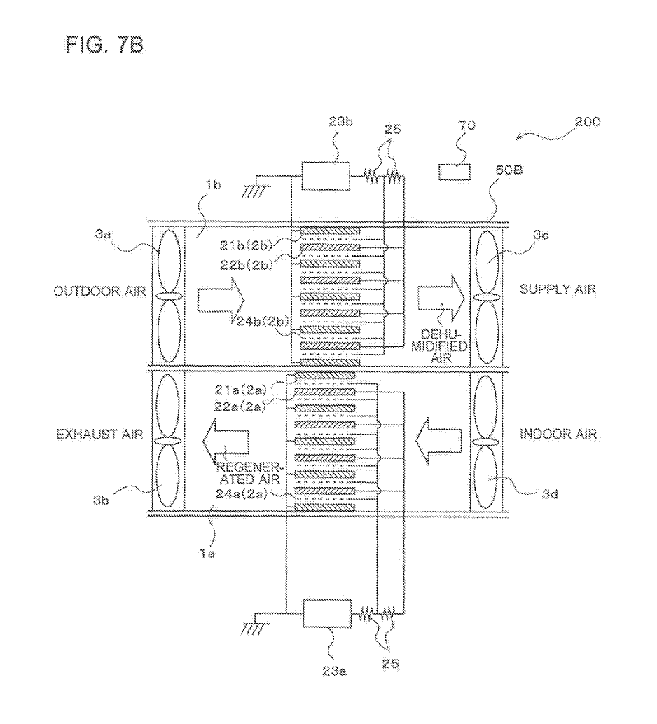

FIG. 7A illustrates the humidity control apparatus 200 according to Embodiment 2 in which the humidity control unit 2a performs an adsorption process and the humidity control unit 2b performs a desorption process. FIG. 7B illustrates the humidity control apparatus 200 according to Embodiment 2 in which the humidity control unit 2a performs a desorption process and the humidity control unit 2b performs an adsorption process. FIGS. 7A and 7B illustrate how dehumidification is performed. For example, the operation illustrated here is one that is carried out to reduce indoor humidity when outdoor humidity is high due to rain in summer.

The humidity control apparatus 200 has an air passage is and an air passage 1b each serving as an air passage in a housing 50B. The humidity control unit 2a is disposed in the air passage 1a, and the humidity control unit 2b is disposed in the air passage 1b. The humidity control unit 2a is connected to a power supply unit 23a, and the humidity control unit 2b is connected to a power supply unit 23b. The air passage 1a is provided with a fan 3a and a fan 3c, and the air passage 1b is provided with a fan 3b and a fan 3d. The air passage 1a and the air passage 1b allow air to flow in opposite directions. That is, the fan 3a and the fan 3b are fans for causing wind to flow from right to left in the drawing, whereas the fan 3c and the fan 3d are fans for causing wind to flow from left to right in the drawing. The fan 3b and the fan 3c are off during operation of the fan 3a and the fan 3d, and the fan 3a and the fan 3d are off during operation of the fan 3b and the fan 3c.

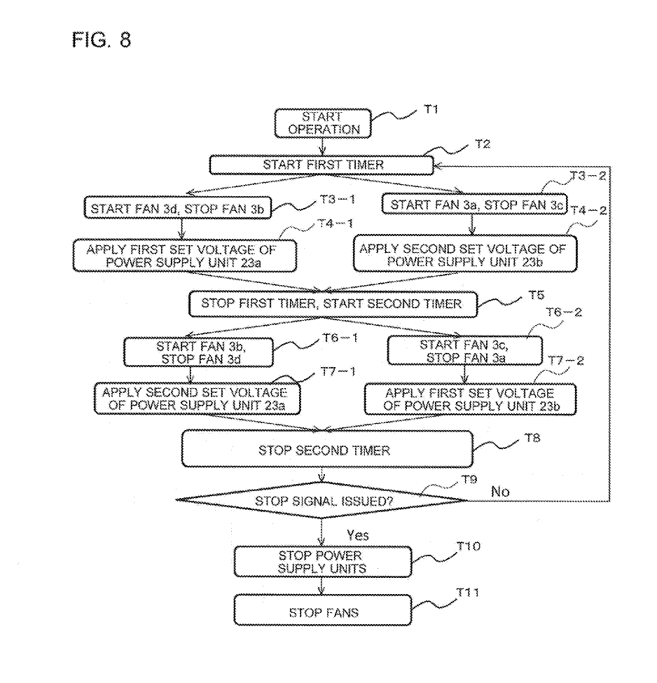

FIG. 8 is a control flowchart of the humidity control apparatus 200 according to Embodiment 2. The operation of the humidity control apparatus 200 will be described along the flowchart of FIG. 8. At the start of the operation (step T1) the first timer starts (step T2). In the air passage 1a, the fan 3d operates (step T3-1) to cause outdoor air to flow from left to right in the drawing and into the room. The power supply unit 23a applies a first set voltage for adsorption to the humidity control unit 2a (step T4-1).

After moisture in the outdoor air is adsorbed onto the humidity control unit 2a, the resulting air is supplied into the room. The fan 3a operates in the air passage 1b (step T3-2). The indoor air is thus exhausted to the outside for ventilation. The power supply unit 23b applies a second set voltage for adsorbent regeneration to the humidity control unit 2b (step T4-2). Thus, moisture adsorbed by the adsorbent on the humidity control unit 2b is released into the outdoor air to regenerate the adsorbent.

After the elapse of a period of time set in the range of 5 minutes to 180 minutes on the first timer, the second timer starts (step T5). The fan 3d is stopped and the fan 3b is started in the air passage 1a (step T6-1). Then, the power supply unit 23a applies the second set voltage for desorption to the humidity control unit 2a (step T7-1).

The fan 3a is stopped and the fan 3c is started in the air passage 1b (step T6-2). Then, the power supply unit 23b applies the first set voltage for adsorption to the humidity control unit 2b (step T7-2).

When the second timer stops (step T8), if no stop signal is issued (step T9), the controller 70 starts the first timer again and, reverses the directions of air flow in the air passage 1a and the air passage 1b. If a stop signal is issued, the controller 70 stops the power supply unit 23a and the power supply unit 23b (step T10) and stops the fan 3b and the fan 3c (step T11).

Although a dehumidifying operation has been described herein, humidification is also possible. A humidifying operation will now be described. For example, when the outdoor air is dry in winter, the fan 3c starts in the air passage 1a at the start of the operation to cause outdoor air to flow from left to right in the drawing and into the room. The power supply unit 23a applies the second set voltage for adsorbent regeneration to the humidity control unit 2a. Then, moisture desorbed from the humidity control unit 2a is mixed into the air and supplied to the room.

In the air passage 1b, the fan 3a operates and the power supply unit 23b applies the first set voltage for adsorption to the humidity control unit 2b. After moisture in the indoor air is adsorbed onto the humidity control unit 2b, the resulting air is exhausted to the outside for ventilation,

Then, after the elapse of a period of time set on the first timer, the fan 3c is stopped and the fan 3d is started in the air passage 1a, and the fan 3a is stopped and the fan 3d is started in the air passage 1b. The power supply unit 23a applies the first set voltage for adsorption to the humidity control unit 2a. The power supply unit 23b applies the second set voltage for adsorbent regeneration to the humidity control unit 2b.

In Embodiment 2, the power supply unit 23a and the power supply unit 23b apply, to the humidity control unit 2a and the humidity control unit 2b, respectively, the first set voltage, for moisture adsorption or the second set voltage for adsorbent regeneration (i.e., moisture desorption). However, the configuration is not limited to this. For example, the power supply unit 23a may be configured in advance to be able to apply the first set voltage for adsorption, and the power supply unit 23b may be configured in advance to be able to apply the second set voltage for adsorbent regeneration (i.e., desorption). That is, for moisture adsorption in the humidity control unit 2a, the power supply unit 23a is connected to the humidity control unit 2a and the power supply unit 23b is connected to the humidity control unit 2b. For adsorbent regeneration or desorption of adsorbed moisture in the humidity control unit 2a, the connection during moisture adsorption is changed such that the power supply unit 23a is connected to the humidity control unit 2b and the power supply unit 23b is connected to the humidity control unit 2a. The humidity control apparatus 100 may thus be configured to be able to switch the connection between that for moisture adsorption and that for moisture desorption.

In Embodiment 2, the adsorbing operation and the desorbing operation in the humidity control unit 2a and the humidity control unit 2b are switched or stopped on the basis of the first timer and the second timer, but the configuration is not limited to this. For example, instead of using the first timer and the second timer, humidity sensors 81 to 84 may be used so that the operations are switched or stopped when a predetermined humidity is reached.

In the flowchart of FIG. 8 according to Embodiment 2, switching between adsorption and desorption is performed multiple times unless a stop signal is issued (step T9). However, the configuration is not limited to this. That is, the humidity control apparatus 200 may be configured such that the adsorbing operation and the desorbing operation of the humidity control unit 2a and the humidity control unit 2b are switched only once.

### Embodiment 3

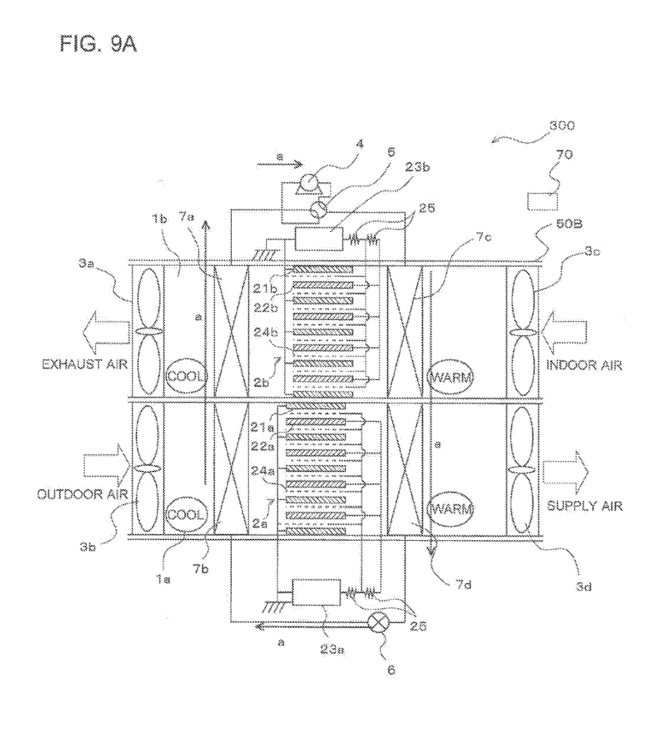

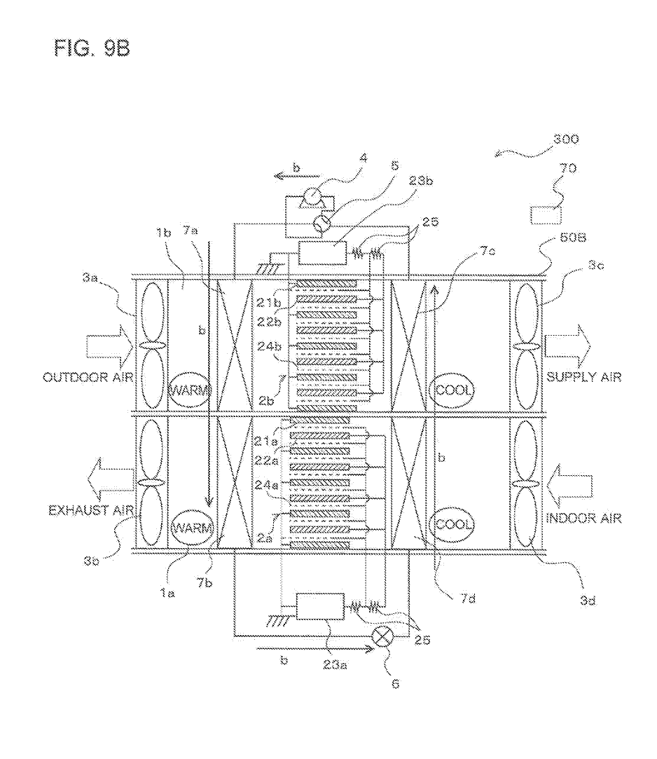

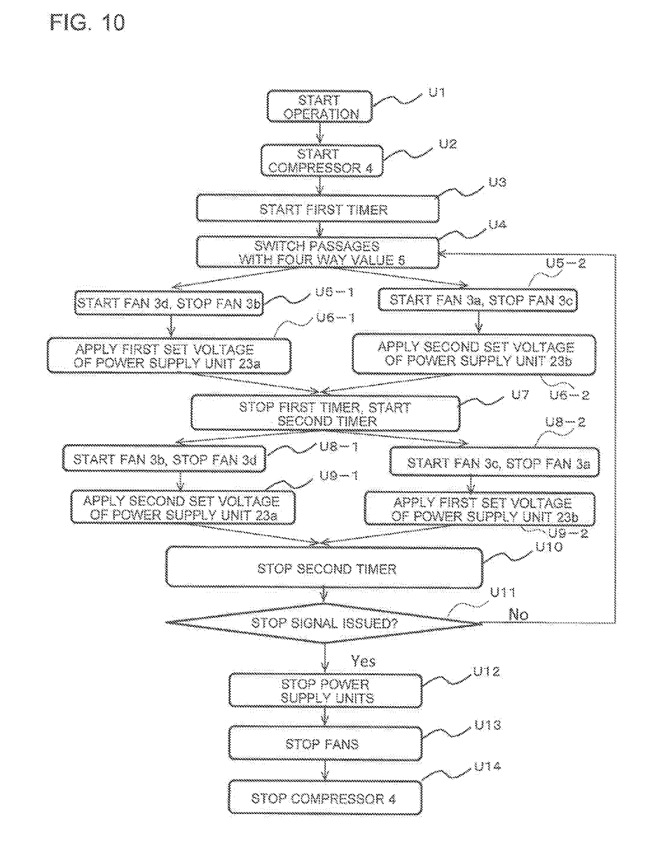

FIG. 9A illustrates a configuration and a dehumidifying operation of the humidity control apparatus 300 according to Embodiment 3. FIG. 9B illustrates a humidifying operation of the humidity control apparatus 300 according to Embodiment 3. FIG. 10 is a control flowchart of the humidity control apparatus 300 according to Embodiment 3.

Embodiment 3 is obtained by adding a refrigerant circuit including a compressor 4 to the configuration described in Embodiment 2. That is, the humidity control apparatus 300 includes the compressor 4, a four-way valve 5, an expansion device 6, and heat exchangers 7a to 7d. The operation of Embodiment 3 will now be described on the basis of the flowchart of FIG. 10. In response to an instruction to start the operation (step U1) the compressor 4 starts (step U2) and a first timer setting starts (step U3). The four-way valve 5 is switched to a refrigerant flow direction “a” (step U4) to allow refrigerant to flow through the compressor 4, the four-way valve 5, the heat exchanger 7c, the heat exchanger 7d, the expansion device 6, the heat exchanger 7b, and the heat exchanger 7a in this order.

In this case, the heat exchanger 7a and the heat exchanger 7b each serve as an evaporator to extract cooling energy, whereas the heat exchanger 7c and the heat exchanger 7b each serve as a condenser to extract heating energy. Generally, as the temperature of the adsorbent increases, molecular motion is accelerated and desorption bee dominant over adsorption.

Therefore, as in FIG. 10, the fan 3b is stopped and the fan 3d is started in the air passage 1a (step U5-1). The power supply unit 23a applies a first set voltage to the humidity control unit 2a (step U6-1). The outdoor air is taken in by the fan 3d, passes through the heat exchanger 7b that extracts cool heat, the humidity control unit 2a to which the first set voltage is applied by the power supply unit 23a, and the heat exchanger 7d that extracts warm heat, and is supplied as supply air to the room.

On the other hand, the fan 3a is started and the fan 3c is stopped in the air passage 1b (step U5-2). The power supply unit 23b applies a second set voltage to the humidity control unit 2a (step U6-2). The outdoor air is taken from the room into the air passage 1b by the fan 3a, passes through the heat exchanger 7c that extracts warm heat, the humidity control unit 2b to which the second set voltage for adsorbent regeneration or desorption is applied by the power supply unit 23b, and the heat exchanger 7a that extracts cool heat, and is exhausted to the outside.

After the first timer stops (step U7), the second timer starts. The fan 3d is stopped and the fan 3b is started in the air passage 1a (step U8-1), and the fan 3a is stopped and the fan 3c is started in the air passage 1b (step U8-2).

In this case, the power supply unit 23a applies the second set voltage for desorption to the humidity control unit 2a (step U9-1), and the power supply unit 23b applies the first set voltage for adsorption to the humidity control unit 2b (step U9-2). After the elapse of a period of time set on the second timer (step U10), if no stop signal is issued (step U11), the first timer starts again and the directions of air flow in the air passage 1a and the air passage 1b are reversed. If a stop signal is issued, the power supply unit 23a and the power supply unit 23b are stopped (step U12), the fan 3b and the fan 3d are stopped (step U13), and the compressor 4 is stopped (step U14). Note that the present configuration is designed to control humidity to make the room comfortable when the outdoor air is humid.

When the outdoor air is dry as in winter, and the indoor humidity needs to increase, the four-way valve 5 is switched to a refrigerant flow direction “b” as illustrated in FIG. 9B. This allows the refrigerant from the compressor to pass through a circuit extending from the heat exchangers 7a and 7b, the expansion device 6, and the heat exchangers 7d and 7c, passing through the four-way valve 5 again, and returning to the compressor. Next, in the air passage 1a, air taken in from the room passes through the heat exchanger 7d that supplies cool heat the humidity control unit 2a to which the first set voltage for adsorption is applied, and the heat exchanger 7b that supplies warm heat. Then the air is exhausted to the outside.

In the air passage 1b, air passed through the heat exchanger 7a that supplies warm heat is mixed with moisture in the humidity control unit 2a to which the second set voltage for desorption is applied, and is supplied through the heat exchanger 7c to the room. With this configuration, adsorption is accelerated by discharge, adsorption heat generated during adsorption is removed, and stable dehumidifying performance can be achieved. During desorption, combination with discharge allows faster regeneration of the adsorbent, and humidity supplied when the outdoor air is dry can be controlled by energy used for the discharge.

In the humidity control apparatus 300 according to Embodiment 3, the adsorbent is attached to the humidity control unit 2a and the humidity control unit 2b, not to the heat exchangers 7a to 7d. Therefore, it is possible to reduce an increase in pressure loss resulting from narrowing of spaces between adjacent fins of the heat exchangers 7a to 7d caused by the presence of adsorbent attached to the heat exchangers 7a to 7d. Also, it is possible to reduce an increase in the size of the humidity control apparatus caused by widening the spaces between the fins to reduce pressure loss.

### REFERENCE SIGNS LIST

1 air passage, 1a air passage, 1b air passage, 2 humidity control unit, 2a humidity control unit, 2b humidity control unit, 3 fan, 3a fan, 3b fan, 3c fan, 3d fan, 4 compressor, 5 four-way valve, 6 expansion device, 6B electrode, 7a heat exchanger, 7b heat exchanger, 7c heat exchanger, 7d heat exchanger, 20 humidity control unit, 21 electrode, 22 electrode, 23 power supply unit, 23a power supply unit, 23b power supply unit, 24 electrode, 25 resistor, 50 housing, 50B housing, 70 controller, 81 humidity sensor, 100 humidity control apparatus, 200 humidity control apparatus, 210 electrode, 211 partition wall, 212 adsorbent, 213 through hole, 220 electrode 220A electrode 220A1 base portion, 220A2 protrusion, 230 power supply unit, 240 electrode, 300 humidity control apparatus

1. A humidity control apparatus comprising:
a housing having an air passage formed therein;
a humidity control unit including a first electrode provided in the air passage and having an adsorbent attached thereto, a second electrode provided in the air passage and disposed along the first electrode, and a third electrode interposed between the first electrode and the second electrode and having a potential intermediate between potentials of the first electrode and the second electrode;
a power supply unit configured to apply a voltage to the first electrode and the second electrode; and
a fired configured to supply air to the air passage to cause the air to flow through the humidity control unit,
the third electrode being configured such that the an passes in a direction from one of the first electrode and the second electrode to an other one of the first electrode and the second electrode.

2. The humidity control apparatus of claim 1, wherein the first electrode and the second electrode have a flat plate-like shape,
the first electrode and the second electrode are arranged such that a direction from the first electrode toward the second electrode is orthogonal to a direction of flow of the air flowing through the air passage, and
the third electrode has a mesh-like shape.

3. The humidity control apparatus of claim 1, wherein the humidity control unit includes a plurality of first electrodes including the first electrode, a plurality of second electrodes including the second electrode, and a plurality of third electrodes including the third electrode, and
each of the first electrodes and each of the second electrodes are alternately arranged, and each of the third electrode is interposed between each of the first electrodes and each of the second electrodes.

4. The humidity control apparatus of claim 1, wherein the first electrode is a flat plate-like member having a plurality of through holes, and
the adsorbent is attached onto a partition wall that separate the through holes.

5. The humidity control apparatus of claim 4, wherein the first electrode is arranged such that a penetrating direction of the through holes is parallel to a direction of flow of the air flowing through the air passage.

6. The humidity control apparatus of claim 5, wherein the second electrode has a plurality of protrusions protruding toward the first electrode.

7. The humidity control apparatus of claim 1 further comprising a plurality of humidity control units including a first humidity control unit and a second humidity control unit, wherein
the air passage in the housing includes a first air passage and a second air passage isolated from the first air passage,
the fan includes a first fan and a second fan,
the first air passage is provided with the first humidity control unit and the first fan, and
the second air passage is provided with the second humidity control unit and the second fan.

8. The humidity control apparatus of claim 7, further comprising a controller configured to control the power supply unit,
wherein the controller is configured to control the power supply unit to apply a first set voltage to passage one of the first humidity control unit and the second humidity control unit such that moisture is adsorbed on the first electrode, and controls the power supply unit to apply a second set voltage different from the first set voltage to an other of the first humidity control unit and the second humidity control unit such that moisture is desorbed on the first electrode.

9. The humidity control apparatus of claim 8, wherein the controller is configured to control the first fan and the second fan to cause air flowing through the first air passage and air flowing through the second air passage to flow in opposite directions.

10. The humidity control apparatus of claim 8, wherein the controller is configured to switch between
a first control which the moisture is adsorbed on the adsorbent of the first electrode provided in the first humidity control unit and the moisture is desorbed from the adsorbent of the first electrode provided in the second humidity control unit, and
a second control in which the moisture is desorbed from the adsorbent of the first electrode provided in the first humidity control unit, and the moisture is adsorbed on the adsorbent of the first electrode provided in the second humidity control unit.

11. The humidity control apparatus of claim 10, wherein after elapse of a predetermined period of time, the controller is configured to switch between the first control and the second control.

12. The humidity control apparatus of claim 10, further comprising a humidity sensor configured to detect a humidity in the first air passage and the second air passage,
wherein the controller is configured to switch between the first control and the second control based on a result of detection by the humidity sensor.

13. The humidity control apparatus of claim 8, further comprising a refrigerant circuit including a compressor, a condenser, an expansion device, and an evaporator connected to each other by refrigerant pipes,
wherein the first humidity control unit in the first air passage and the second humidity control unit in the second air passage are interposed between the condenser and the evaporator.
